(19) United States
(12) Patent Application Publication
(10) Pub. No.: US 2004/0085973 A1
(43) Pub. Date: May 6, 2004

(54) Communication apparatus and network interfacing device

(76) Inventor: Toru Tanada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/697,542

(22) Filed: Oct. 30, 2003

(30) Foreign Application Priority Data
Oct. 31, 2002 (JP) 2002-318731

(51) Int. Cl. H04L 12/28; H04L 12/56

(52) U.S. Cl. 370/401

(57) ABSTRACT

The invention relates to a network interfacing device and a communication apparatus that is provided in a packet routing network and accommodates a large number of VPNs. An object of the invention is to accommodate a large number of VPNs with low cost. The communication apparatus have: a plurality of interfacing sections each having a CAM and interfacing with links that are used for accommodating respective VPNs, for performing routing according to information stored in the CAM; a storage section for registering in advance therein a combination of identifiers of interfacing sections which accommodate VPNS respectively; and a controlling section for requesting an interfacing section designated by an identifier registered in the storage section in association with a VPN to which routing information is to be applied, to write the routing information into the CAM.

### CROSS REFERENCE TO RELATED APPLICATION

This application is based upon and claims the benefit of priority from Japanese Patent Application No. 2002-318731, filed on Oct. 31, 2002, the entire contents of which are incorporated herein by reference.

### BACKGROUND OF THE INVENTION

1. Field of the Invention

The present invention relates to a communication apparatus that is provided at a node of a packet routing network for accommodating therein a large number of VPNs (virtual private networks) while a plurality of network interfaces each having a CAM (content-addressable memories) performs load distribution. It also relates to a network interfacing device which is equivalent to each of the network interfaces.

2. Description of the Related Art

In recent years, the Internet has come to be utilized as a VPN which advantageously achieves the following points by applying thereto a technology for realizing encipherment of transmission information and securing a desired transmission band as well as a protocol and other highly advanced technologies for realizing tunneling and authentication.

Substantial reduction in the communication cost

Business expansion with low cost by utilizing e-commerce or the like

Heightening various added values of a communication service

Efficient equipment Investment

FIG. 6 shows an example IP network in which a plurality of VPNs are formed. In FIG. 6, routers 41-1 to 41-3 are provided as nodes in an IP network 42 and accommodate VPN1 to VPN3 that are assigned unique IP addresses.

For the sake of simplicity, it is assumed that VPN1 is formed between a plurality of sites of company A, VPN2 is formed between a plurality of sites of company B, and VPN3 is formed between a plurality of sites of company C.

As shown in FIG. 7, the router 41-1 is composed of the following components:

Crossbar switch 51-1

Network interfacing parts 52-11 to 52-13 that are connected to respective ports of the crossbar switch 51-1 and links via which the VPN1 to VPN3 are accommodated, respectively.

A controlling part 53-1 having input/output ports (communication ports) that are connected to respective control input/output terminals of the crossbar switch 51-1 and the network interfacing parts 52-11 to 52-13.

The network interfacing part 52-11 is composed of a crossbar interfacing part 61-11, a routing controlling part 62-11, a filtering controlling part 63-11, and a line controlling part 64-11 that are provided in cascade between the corresponding port of the crossbar switch 51-1 and the corresponding one of the above-mentioned links and are connected to the corresponding input/output port (communication port) of the controlling part 53-1 via an internal bus 60-11.

The routing controlling part 62-11 is provided with a processor 65-11 that is connected to the internal bus 60-11 and a CAM 66-11 and an SRAM 67-11 that are accessed by the processor 65-11.

The network interfacing parts 52-12 and 52-13 have the same configuration as the network interfacing part 52-11. Components of the network interfacing parts 52-12 and 52-13 having corresponding components in the network interfacing part 52-11 will be referred to by using suffixes “12” and “13” though they are not shown in FIG. 7 and they will not be described in detail.

The routers 41-2 and 41-3 have the same configuration as the router 41-1. Components of the routers 41-2 and 41-3 having corresponding components in the router 41-1 will be referred to by using first suffixes “2” and “3” though no drawings are provided and they will not be described in detail.

The operation of the routers 41-1 to 41-3 will be described below. Items common to the routers 41-1 to 41-3 will be described below by using, instead of the first suffixes “1” to “3,” a character “C” meaning that it may be any of “1” to “3.” Further, items common to the network interfacing parts 52-C1 to 52-C3 that are provided in the router 41-C will be described below by using, instead of the second suffixes “1” to “3,” a character “c” meaning that it may be any of “1” to “3.”

The CAM 66-Cc has storage areas where to store words (hereinafter referred to as “CAM words”) each of which is a combination of the following items (see FIG. 8). SRAM words (described later) corresponding to the respective CAM words are stored in the SRAM 67-Cc in corresponding order.

An input port number indicating a unique input port to be used for accommodating a corresponding VPN among the input ports of the network interfacing parts 52-C1 to 52-C3.

A unique VPN identifier indicating the above VPN.

An IP address that is contained in a packet (for the sake of simplicity, it is assumed that the packet is input in such a state as to be multiplexed to assume a frame having a predetermined format and is given by demultiplexing the frame) received via the above input port and that is unique to a VPN that is given to a site (indicating a router or an output port of a router) as a transfer destination of the packet.

The SRAM 67-Cc has storage areas that are given the same addresses as addresses (hereinafter referred to as “associative addresses”) of storage areas of the CAM 66-Cc where individual effective CAM words are stored. A word (hereinafter referred to as “SRAM word”) that is a combination of the following items is stored in each storage area of the SRAM 67-Cc:

An output port number indicating an output port, among the output ports of the network interfacing parts 52-C1 to 52-C3, to be used for relaying a packet concerned.

An XB port number indicating a port that is connected to a network interfacing part having the output port, among the ports of the crossbar switch 51-C, that is indicated by the above output port number.

Control information to be used for a QoS control, a priority control, etc.

The controlling part 53-C performs the following processing in cooperation with the network interfacing parts 52-C1 to 52-C3:

Acquires routing information according to an OSPF (open shortest path first), RIP (routing information protocol), BGP (border gateway protocol) and other predetermined routing protocol and announces it.

Selects optimum routes on the basis of the acquired routing information.

Converts pieces of routing information corresponding to the respective selected routes among the acquired pieces of routing information into pairs of a CAM word and an SRAM word and accumulates those as they are produced.

Delivers CAM words and SRAM words corresponding to all the selected routes to the processor 65-Cc of the routing controlling part 62-Cc.

The processor 65-Cc stores the thus-delivered CAM words and SRAM words in the CAM 66-Cc and the SRAM 67-Cc, respectively.

In the network interfacing part 52-Cc, the routing controlling part 62-Cc (processor 65-Cc) acquires the following information upon receiving a packet via the line controlling part 64-Cc and the filtering controlling part 63-Cc:

An input port number indicating an input port via which the packet has been received and a VPN identifier that is correlated with the input port number.

An IP address contained in the frame together with the input port number and the VPN identifier.

In the following, for the sake of simplicity, a network interfacing part 52-Cc where a packet has been received via the line controlling part 64-Cc and the filtering controlling part 63-Cc will be called “input network interfacing part” 52-Cc.

The routing controlling part 62-Cc (processor 65-Cc) supplies the CAM 66-Cc with a CAM word that consists of the input port number, the VPN identifier, and the IP address.

The CAM 66-Cc outputs an associative address that is an address of a storage area where the CAM word is stored among the storage areas of the CAM 66-Cc (indicated by symbol (1) in FIG. 8).

The routing controlling part 62-Cc (processor 65-Cc) acquires an SRAM word that is stored in a storage area designated by the associative address among the storage areas of the SRAM 67-Cc (indicated by symbol (1) in FIG. 9).

Further, the routing controlling part 62-Cc (processor 65-Cc) delivers, to the crossbar switch 51-C. via the crossbar interfacing part 61-Cc, the output port number, the XB port number, and the control information that are contained in the SRAM word and transmission information contained in the packet (for the sake of simplicity, it is assumed that the transmission information includes the VPN identifier and the IP address that are contained in the CAM word).

The crossbar switch 51-C delivers, to a network interfacing part (hereinafter referred to as “output network interfacing part”; it is assumed that the output network interfacing part is designated by the output port number that has been delivered together with the XB port number) that is connected to a port designated by the thus-delivered XB port number among the ports of the crossbar switch 51-C, the above-mentioned transmission information and the control information that has been delivered together with the XB port number and the output port number.

The output network interfacing part forms a VPN via the IP network 42 and provides a communication service via the VPN by performing processing that is reverse to processing performed by each part of the input network interfacing part.

The router 41-C can accommodate a number of VPNs under load distribution by the network interfacing parts 52-C1 to 52-C3 as long as sufficient storage areas are secured in the CAMs 66-C1 to 66-C3 and the SRAMs 67-C1 to 67-C3 and sufficient throughput is secured in the routing controlling parts 62-C1 to 62-C3 (processors 65-C1 to 65-C3) (e.g., refer to claim 1 and paragraph 0004 of JP-A-261078/1994).

However, in the above-described conventional example, CAM words that are generated by the controlling part 53-C by individually converting all pieces of routing information obtained by cooperating with the network interfacing parts 52-11 to 52-13, . . . , 52-31 to 52-33 are stored, in common, in all of the CAMs 66-C1 to 66-C3.

That is, CAM words relating to VPNs to be accommodated via network interfacing parts other than the network interfacing parts 52-C1 to 52-C3 are stored in the CAMs 66-C1 to 66-C3.

Nowadays, the demand for VPN services is increasing rapidly. It is impossible to satisfy such demand unless the number of network interfacing parts to be provided in the router 41-C and the maximum number of VPNs to be accommodated via each network interfacing part are set properly without lowering the price performance and the reliability.

However, it is probable that the maximum number of VPNs to be accommodated via each network interfacing part will reach 1,000 and the total number of routes to be formed in association with those VPNs will reach 250,000 to 1,000,000.

In general, although basically the responsibility of the CAM 66-Cc does not lower even if a number of CAM words are stored (registered) there in parallel to satisfy such increase in demand (the maximum storable number of CAM words in parallel in this manner will be hereinafter referred to as “entry number”), the power consumption increases steeply as the entry number increases.

Where a large number, over the maximum entry number, of VPNs are accommodated via the network interfacing part 52-Cc, CAM words relating to one of the VPNs that is heavy in traffic may be stored in the CAM 66-Cc preferentially.

However, in practice, it is difficult to employ this measure because it is highly probable that the total responsibility lowers because during busy hours and other period when communications for which CAM words are not registered in the CAM 66-Cc occur in a concentrated manner those communications are delivered to the controlling part 53-C as appropriate.

Such an increase in power consumption can be reduced by, for example, dividing the storage areas of the CAM 66-Cc into a plurality of partitions and supplying drive power only to partitions to be searched.

However, in practice, it is difficult to employ such a CAM 66-Cc because a complex additional circuit needs to be provided to avoid the above-mentioned reduction in responsibility.

### SUMMARY OF THE INVENTION

An object of the present invention is to provide a communication apparatus and a network interfacing device that enable accommodation of a much larger number of VPNs than those in the conventional example without causing any substantial alterations in hardware.

Another object of the invention is to have the number of entries of a CAM to which each interfacing refers be much smaller than in the conventional example.

Another object of the invention is to allow the communication apparatus and the network interfacing device to be adaptable to a variety of network structures.

Another object of the invention is to have the number of entries provided in each CAM be much smaller than in the conventional example.

Still another object of the invention is to simplify wiring for delivery of routing information and to adapt to expansion of network interfacing devices according to the invention.

Another object of the invention is to form a variety of combinations of VPNs with low cost.

Another object of the invention is to simplify wiring to be used for cooperation between a controlling section and interfacing sections and to relax restrictions on not only pin assignment for each package (module) but also packaging.

Another object of the invention is to adapt to the expansion of the wiring as well as to simplify the wiring.

Yet another object of the invention is to distribute the load and function of one or both of a control section and interfacing sections and to expand one or both thereof with sureness.

Another object of the invention is to maintain high performance and reliability of a communication apparatus incorporating a plurality of network interfacing devices according to the invention.

A further object of the invention is to keep the number of entries provided in each CAM small with reliability, irrespective of the order in which pieces of routing information are supplied or updated.

Another object of the invention is to form a large number of and a variety of VPNs in parallel with low cost without impairing transmission quality or service quality in a network to which the invention is applied.

The above objects are achieved by a first communication apparatus in which a plurality of interfacing sections each have a CAM and accommodate a VPN therein. A combination of identifiers of the interfacing sections is registered in advance for each VPN. An interfacing section associated with a VPN to which routing information is applied is given a request to write the routing information to the CAM thereof. In this communication apparatus, routing information written to the CAMs is routing information relating only to VPNs that are accommodated or to be accommodated individually under the load distribution of the interfacing sections.

The above objects are achieved by a second communication apparatus which can omit requesting for writing redundant pieces of routing information by comprehending the contents of routing information written to each CAM. In this communication apparatus, only unique routing information is written to each CAM.

The above objects are achieved by a third communication apparatus in which each interfacing section maintains uniqueness of each piece of routing information that is written to the CAM thereof. In this communication apparatus, only unique routing information is written to each CAM.

The above objects are achieved by a fourth communication apparatus in which the interfacing sections each have a CAM therein and have routing information supplied from an exterior, and recognize which distributed VPN is to be accommodated therein, write only routing information, of the externally supplied routing information, to be applied to the VPN to its CAM. In this communication apparatus, pieces of routing information relating only to VPNs are written to the respective CAMs of the interfacing sections. The VPNs are formed or to be formed individually under the load distribution of the interfacing sections.

The above objects are achieved by a fifth communication apparatus which has a switching section for delivering, among the plurality of interfacing sections, a packet whose transmission source and/or destination is/are accommodated in one of the VPNs that is to be accommodated via the interfacing sections. In this communication apparatus, different interfacing sections cooperate with each other so as to form the VPNs with flexibility.

The above objects are achieved by a sixth communication apparatus which interfaces with different autonomous systems or segments which are intervenient in the VPNs. In this communication apparatus, the controlling section and the interfacing sections are cooperated with each other via wiring which is laid in parallel with or combined with the ports that are connected to the respective interfacing sections.

The above objects are achieved by a seventh communication apparatus in which one or both of functions and loads of the controlling section are distributed to ports that are provided in the switching section, and the ports request for writing routing information to the CAMS. As a result the load of the controlling section is reduced in this communication apparatus.

The above objects are achieved by an eighth communication apparatus in which the switching section delivers all of the routing information between the controlling section and the interfacing sections. In this communication apparatus, the control section and the interfacing sections are roughly coupled in terms of both of hardware and software.

The above objects are achieved by a ninth communication apparatus in which the controlling section delivers the routing information to the interfacing sections via a communication link. The VPNs can be formed freely between the communication apparatus and different autonomous systems or segments.

The above objects are achieved by a first network interfacing device which corresponds to the interfacing section provided in the above-described communication apparatus. The network interfacing device does not write to the CAM routing information which relates to a VPN formed not via the network interfacing device.

The above objects are achieved by a second network interfacing device which autonomously maintains the uniqueness of the information stored in the CAM. In this network interfacing device, the throughput necessary for delivering routing information to the network interfacing device according to the invention is distributed to the switch.

The above objects are achieved by a third network interfacing device which requests an exterior to supply routing information when a predetermined event has occurred, the routing information being used for updating the information stored in the CAM. In this network interfacing device, only unique routing information is written to the CAM.

The above objects are achieved by a fourth network interfacing device which obtains externally delivered routing information via a port of a switch. In this network interfacing device, information written to and stored in the CAM can be updated when necessary in response to an event which the controlling section recognizes.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the principles of communication apparatuses according to the present invention;

FIG. 2 is a block diagram showing the principles of network interfacing devices according to the invention;

FIG. 3 is a flowchart showing the operation of a first embodiment of the invention;

FIG. 4 shows the structure of a VPN-NIF table;

FIG. 5 illustrates the operation of a second embodiment of the invention;

FIG. 6 shows an example of IP network in which a plurality of VPNs are formed;

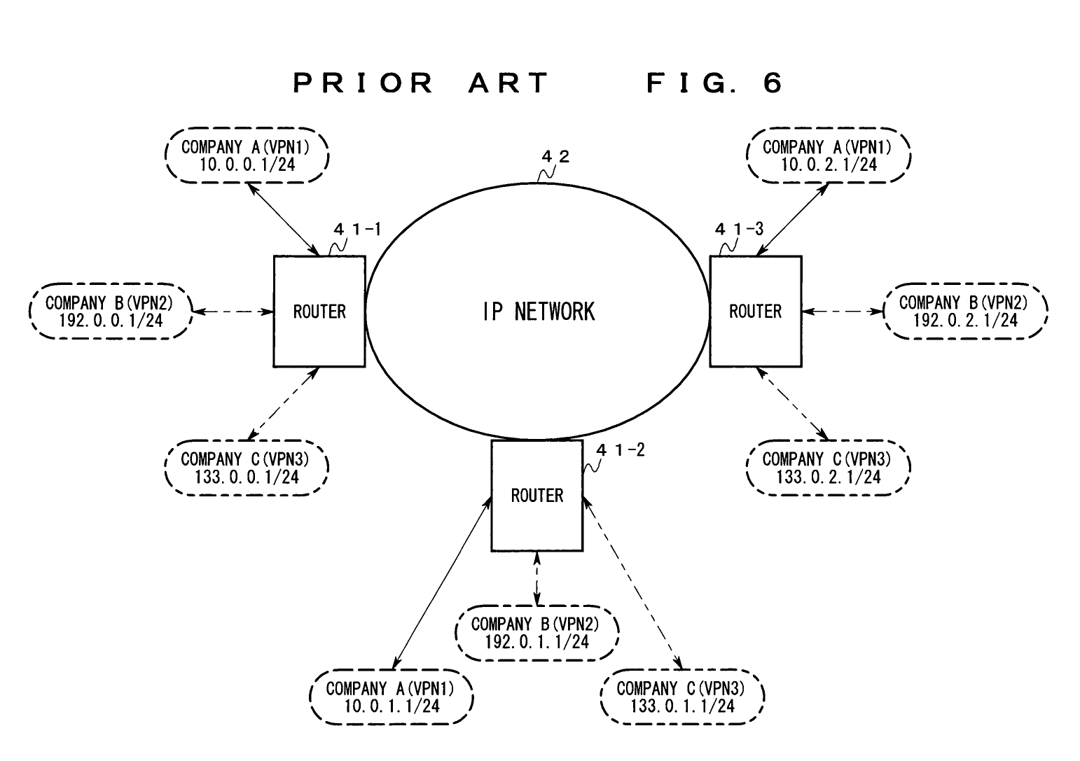

FIG. 7 shows the configuration of a router;

FIG. 8 shows the structure of a CAM word to be stored in a CAM; and

FIG. 9 shows the structure of an SRAM word to be stored in an SRAM.

### DESCRIPTION OF THE PREFERRED EMBODIMENTS

The principles of the present invention will be hereinafter described.

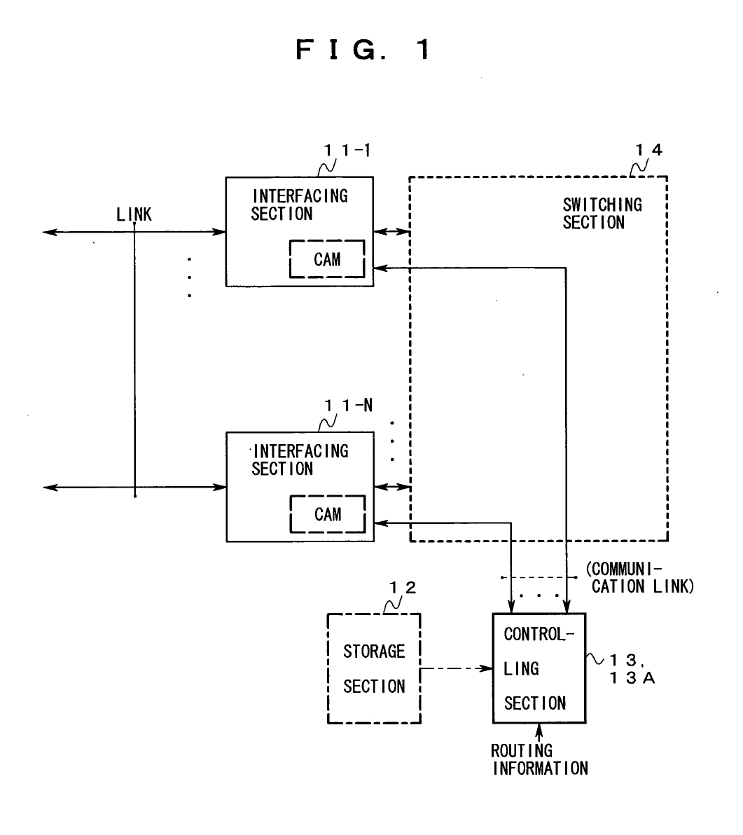

FIG. 1 is a block diagram showing the principles of communication apparatuses according to the invention. Each of the communication apparatuses shown in FIG. 1 is composed of all or part of interfacing sections 11-1 to 11-N, a storage section 12, a controlling section 13 or 13A, and a switching section 14.

In a first communication apparatus according to the invention, the plural interfacing sections 11-1 to 11-N having respective CAMs therein interface with links that are used for accommodating respective VPNs, and perform routing or filtering on the basis of information that is stored in the CAMs. A combination of identifiers of interfacing sections accommodating the VPNs therein is registered in the storage section 12 in advance. The interfacing sections are among the interfacing sections 11-1 to 11-N. The controlling section 13 requests one of the interfacing sections 11-1 to 11-N to write routing information to a CAM thereof. The one of the interfacing sections is designated by an identifier that is registered in the storage section 12 in association with a VPN to which routing information is to be applied.

That is, written to the respective CAMs in the interfacing sections 11-1 to 11-N are pieces of routing information relating only to VPNs that are accommodated or to be accommodated individually under load distribution by the interfacing sections 11-1 to 11-N. This makes the number of entries of the CAM to which each interfacing section refers be much smaller than that in the conventional example.

In a second communication apparatus according to the invention, the controlling section 13 comprehends contents of the routing information that is written to the respective CAMs in the interfacing sections 11-1 to 11-N, and omits requesting for writing overlapping pieces of routing information to the CAMs when the routing information overlaps the contents of the written routing information.

That is, only unique routing information is written to each CAM. This allows the number of entries to be provided in each CAM to be small with reliability irrespective of the order in which pieces of routing information are supplied or updated.

In a third communication apparatus according to the invention, the interfacing sections 11-1 to 11-N maintain uniqueness of each piece of routing information that is written to the respective CAMs provided in the interfacing sections 11-1 to 11-N.

That is, only unique routing information is written to each CAM. Therefore, the number of entries to be provided in each CAM can be kept small irrespective of the order in which pieces of routing information are supplied or updated.

In a fourth communication apparatus according to the invention, the interfacing sections 11-1 to 11-N having respective CAMs interface with links that are used for accommodating respective VPNs, and perform routing or filtering on the basis of information that is stored in the CAMs. The controlling section 13A delivers routing information to be applied to the VPNs to all of the plurality of interfacing sections 11-1 to 11-N. The interfacing sections 11-1 to 11-N write to their respective CAMs routing information which is of the delivered routing information from the controlling section 13A and corresponds to the VPNs that are accommodated via the links.

That is, written to the respective CAMs in the interfacing sections 11-1 to 11-N are pieces of routing information relating only to VPNs that are formed or to be formed individually under load distribution of the interfacing sections 11-1 to 11-N. This realizes substantial reduction in the number of entries of the CAM to which each interfacing section refers, compared with that in the conventional example.

In a fifth communication apparatus according to the invention, the switching section 14 delivers, among the interfacing sections 11-1 to 11-N, a packet whose transmission source and/or destination is/are accommodated in one of the VPNs.

That is, different interfacing sections are cooperated; therefore, all of the VPNs are formed flexibly. This makes it possible to form a variety of combinations of VPNs with low cast as long as the interfacing sections 11-1 to 11-N surely interface with respective transmission sections connected thereto.

In a sixth communication apparatus according to the invention, one or both of functions and loads of the controlling section 13 or 13A are distributed to ports that are provided in the switching section 14 and correspond to the respective interfacing sections 11-1 to 11-N. That is, the controlling section 13 or 13A and the interfacing sections 11-1 to 11-N are cooperated using wiring which is laid in parallel with or combined with the ports that are connected to the respective interfacing sections 11-1 to 11-N. This results in simplifying the wiring and relaxing restrictions not only on a pin assignment for each package (module) but also on packaging.

In a seventh communication apparatus according to the invention, the switching section 14 delivers all of the routing information between the controlling section 13 or 13A and the interfacing sections 11-1 to 11-N. In this case, the load of the controlling section 13 or 13A is reduced by distributing it to the switch 14, compared to when the controlling section 13 or 13A initiatively delivers the routing information to the interfacing sections 11-1 to 11-N. This makes it possible to simplify wiring to be provided between the controlling section 13 or 13A and the interfacing sections 11-1 to 11-N, and to adapt to expansion of interfacing sections.

In an eighth communication apparatus according to the invention, the controlling section 13 or 13A delivers the routing information to the interfacing sections 11-1 to 11-N via a communication link. In this communication apparatus, the control section 13 or 13A and the interfacing sections 11-1 to 11-N are roughly coupled in terms of both of hardware and software. Consequently, this communication apparatus is very adaptable to load distribution, functional distribution, and expansion of one or both of the control section 13 or 13A and the interfacing sections 11-1 to 11-N.

In a ninth communication apparatus according to the invention, the interfacing sections 11-1 to 11-N and the switching section 14 interface with different autonomous systems or segments, which are intervenient in the VPNs, in one of a data link layer and a transport layer. That is, the VPNs can be formed flexibly between different autonomous systems or segments. This enables the communication apparatus of the invention to be adaptable to a variety of network structures.

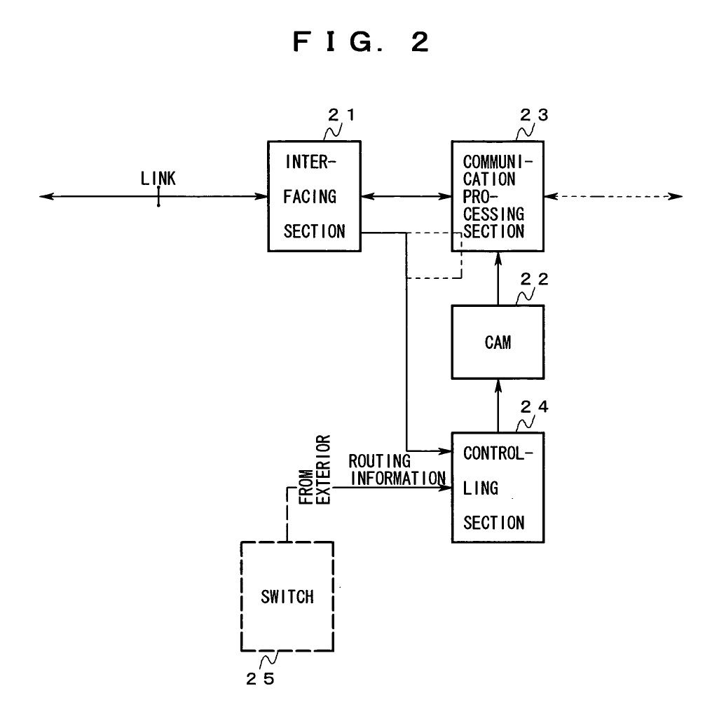

FIG. 2 is a block diagram showing the principles of network interfacing devices according to the invention. Each of the network interfacing devices shown in FIG. 2 is composed of all or part of an interfacing section 21, a CAM 22, a communication processing section 23, and a controlling section 24.

In a first network interfacing device according to the invention, the interfacing section 21 interfaces with a link that is used for accommodating a VPN. The communication processing section 23 performs routing or filtering relating to the VPN according to information stored in the CAM 22. The controlling section 24 writes to the CAM 22 pieces of routing information delivered from an exterior and relating only to the VPNs.

That is, routing information relating to VPNs that are not formed via the network interfacing device according to the invention is not written to the CAM 22. Therefore, the number of entries to be provided in the CAM 22 can be substantially reduced, compared with that in the conventional example in which such routing information is written to the CAM 22.

In a second network interfacing device according to the invention, the controlling section 24 acquires the routing information delivered externally via a port connected to the communication processing section 23 among ports that are provided in a switch 25. The switch 25 realizes the routing or filtering by cooperating with other network interfacing devices. That is, the throughput necessary-for delivery of routing information to the network interfacing device according to the invention is distributed to the switch 25. This makes it possible to simplify the wiring used for delivery of such routing information and adapt to expansion of the network interfacing devices according to the invention.

In a third network interfacing device according to the invention, the controlling section 24 maintains uniqueness of the information stored in the CAM 22. That is, only unique routing information is written to the CAM 22. Therefore, the number of entries to be provided in the CAM 22 can be kept small irrespective of the order in which pieces of routing information are supplied or updated.

In a fourth network interfacing device according to the invention, the controlling section 24 requests the exterior to supply routing information to be used for updating the information stored in the CAM 22 when a predetermined event has occurred. This makes it possible to update information that is written to the CAM 22 and stored therein when appropriate, in response to an event which the controlling section 24 has recognized. Therefore, a communication apparatus incorporating a plurality of network interfacing devices according to the invention can maintain a high reliable performance while these network interfacing devices perform one or both of load distribution and functional distribution.

Embodiments of the invention will be hereinafter described in detail with reference to the drawings.

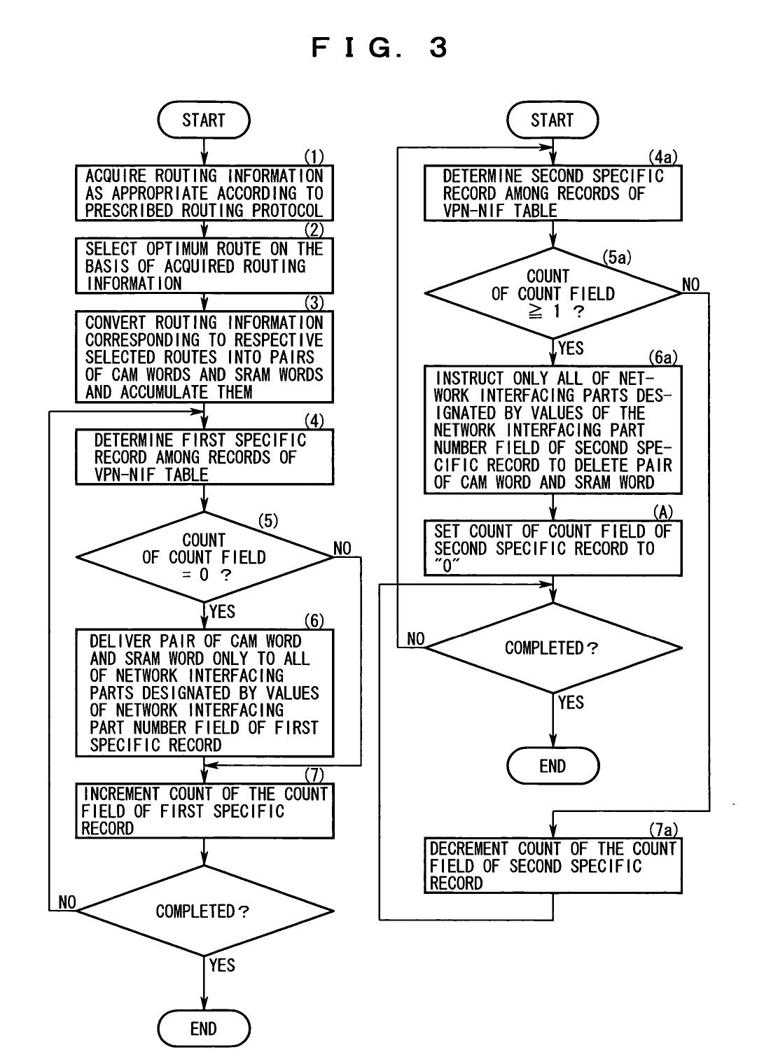

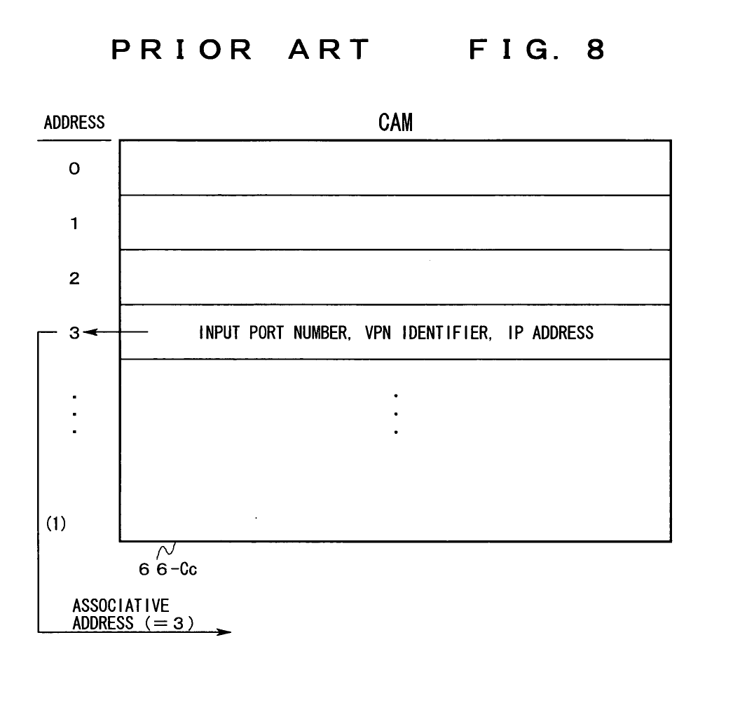

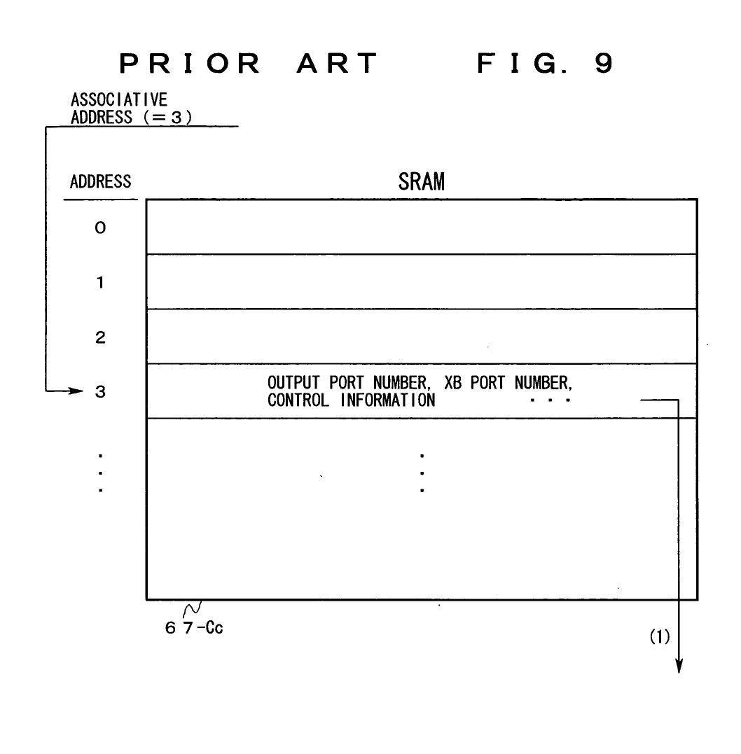

FIG. 3 is a flowchart showing the operation of a first embodiment of the invention. The operation of the first embodiment of the invention will be described below with reference to FIGS. 3 and 7-9.

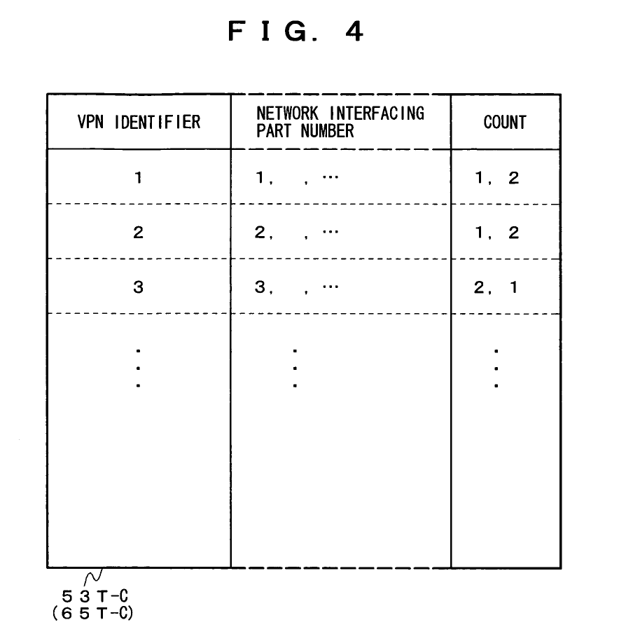

As shown in FIG. 4, a set of records each consisting of the following fields is stored, as a VPN-NIF table 53T-C, in a particular storage area of the main memory of the controlling part 53-C:

A VPN identifier field that contains, in advance, a unique VPN identifier that is given to one of VPN1 to VPN3.

A network interfacing part number field that contains, in advance, an array of unique network interfacing part numbers that are given to a single or a plurality of network interfacing parts, among the network interfacing parts 52-C1 to 52-C3, the single or plurality of network interfacing parts being to be involved with formation and accommodation of a VPN designated by the VPN identifier.

A count field that contains an array of counts that correspond to the network interfacing parts designated by the network interfacing part numbers, respectively, and indicate the number of times a route has been detected in association with the VPN concerned.

The controlling part 53-C cooperates with the network interfacing parts 52-C1 to 52-C3 to perform the following processing:

At the time of initiation, initializes all counts contained in the count fields of all records of the VPN-NIF table 53T-C to “0.”

Acquires routing information as appropriate according to a predetermined routing protocol in the same manner as in the conventional example (indicated by symbol (1) in FIG. 3), and selects an optimum route according to the acquired routing information (indicated by symbol (2) in FIG. 3).

Converts pieces of routing information corresponding to the respective selected routes among the acquired pieces of routing information into pairs of a CAM word and an SRAM word (described above) and accumulates them as they are produced (indicated by symbol (3) in FIG. 3).

Further, the controlling part 53-C performs the following processing for each of the accumulated pairs of a CAM word and an SRAM word:

(1) Determines, among the records of the VPN-NIF table 53T-C, a record (hereinafter referred to as “first specific record”) whose VPN identifier field has the same value as a VPN identifier indicating a VPN that caused acquisition of the routing information concerned (for the sake of simplicity, it is assumed that the acquisition was caused when it was recognized that the VPN concerned should be formed) (indicated by symbol (4) in FIG. 3).

(2) Judges whether all of the counts of the count field of the first specific record are equal to “0” (indicated by symbol (5) in FIG. 4). Only when the judgment result is “true”, delivers the pair of a CAM word and an SRAM word concerned only to all of network interfacing parts designated by the values of the network interfacing part number field of the first specific record (indicated by symbol (6) in FIG. 3).

(3) Irrespective of the above judgment result, increments the counts of the count field of the first specific record as long as the counts do not overflow (indicated by symbol (7) in FIG. 3).

On the other hand, the processor 65-Cc of the network interfacing part 52-Cc stores, in the CAM 66-Cc and the SRAM 67-Cc, respectively, an array of CAM words and an array of SRAM words contained in pairs of a CAM word and an SRAM word that have been delivered to the network interfacing part 52-Cc.

Recognizing that any one of the above-mentioned routes should be deleted, the controlling part 53-C performs the following processing on the corresponding one of the accumulated pairs of a CAM word and an SRAM word:

(1) Determines, among the records of the VPN-NIF table 53T-C, a record (hereinafter referred to as “second specific record”) whose VPN identifier field has the same value as a VPN identifier indicating a VPN for which it was recognized that the route should be deleted (indicated by symbol (4a) in FIG. 3).

(2) Judges whether at least one count of the count field of the second specific record is greater than or equal to “1” (indicated by symbol (5a) in FIG. 3). Only when the judgment result is “true”, performs the following processing:

Instructs only all of network interfacing parts designated by the values of the network interfacing part number field of the second specific record to delete a pair of a CAM word and an SRAM word concerned (indicated by symbol (6a) in FIG. 3).

Sets the counts of the count field of the second specific record to “0” (indicated by symbol (A) in FIG. 3).

(3) If the judgment result is “false,” decrements the counts of the count field of the second specific record as long as the counts do not underflow (indicated by symbol (7a) in FIG. 3).

The processor 65-Cc of the network interfacing part 52-Cc deletes the CAM word and the SRAM word of the above instruction from the array of CAM words and the array of SRAM words stored in the CAM 66-Cc and the SRAM 67-Cc, respectively.

That is, pairs of a CAM word and an SRAM word relating only to VPNs to be accommodated via the network interfaces 52-C1 to 52-C3 are stored in the pair of the CAM 66-C1 and the SRAM 67-Cl, the pair of the CAM 66-C2 and the SRAM 67-C2, and the pair of the CAM 66-C3 and the SRAM 67-C3, respectively.

As described above, according to this embodiment, pairs of a CAM word and an SRAM word to be used only for formation and accommodation of VPNs that are actually effective are stored in the pair of the CAM 66-C1 and the SRAM 67-C1, the pair of the CAM 66-C2 and the SRAM 67-C2, and the pair of the CAM 66-C3 and the SRAM 67-C3.

Therefore, the router 41-C can accommodate, with high reliability and low cost, a much larger number of VPNs than in the conventional example without causing any substantial alterations in hardware.

Further, according to this embodiment, it is not necessary to change the number of entries of an existing CAM to be provided in each of these network interfacing parts as long as the load taken for the formation and accommodation of the VPNs is distributed to a maximum mountable number of network interfacing parts, even if the number of VPNs to be accommodated is large.

This embodiment describes an example where it is prevented that redundant CAM and SRAM words are stored in the pair of the CAM 66-C1 and the SRAM 67-Cl, the pair of the CAM 66-C2 and the SRAM 67-C2, and the pair of the CAM 66-C3 and the SRAM 67-C3 in the course of the above-described processings which the controlling part 53-C performs referring to the count fields of the VPN-NIF table 53T-C.

However, the invention is not limited to such a configuration. For example, a modification is possible in which the controlling part 53-C delivers redundant pairs of a CAM word and an SRAM word to the network interfacing part 52-Cc, and the processor 65-Cc of the network interfacing part 52-Cc plays a leading role in autonomously preventing storing the redundant pairs in the CAM 66-Cc and the SRAM 67-Cc.

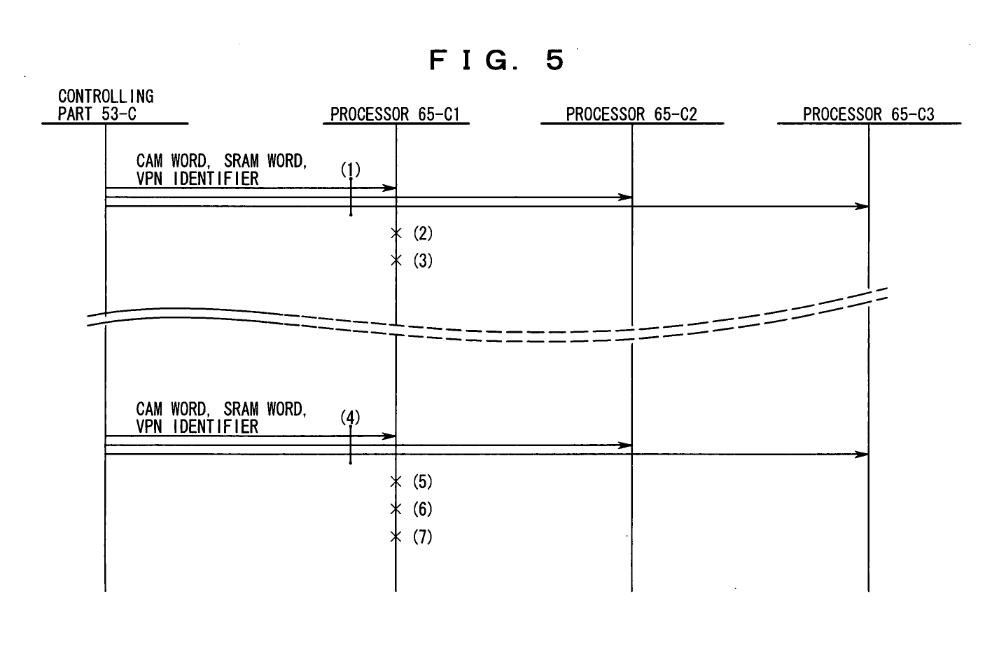

FIG. 5 illustrates the operation of a second embodiment of the invention. The operation of the second embodiment of the invention will be described below with reference to FIGS. 4, 5, and 7-9.

An important feature of this embodiment is the following processing procedure that is performed by the controlling part 53-C and the processor 65-Cc of the network interfacing part 52-Cc.

The VPN-NIF table 53T-C shown in FIG. 4 is allocated not in a storage area of the main memory of the controlling part 53-C but in the main memories of the processors 65-C1 to 65-C3 in a distributed manner that VPN identifier fields contain only VPN identifiers of VPNs, among VPNC-1 to VPNC-3, to be accommodated via the network interfacing part 52-Cc (processor 65-Cc).

For the sake of simplicity, reference symbols 65T-C1 to 65T-C3 instead of 53T-C are given to the VPN-NIF table that is stored in the main memories of the processors 65-C1 to 65-C3 in a distributed manner. And it is assumed that the VPN-NIF tables 65T-C1 to 65T-C3 do not have network interfacing part number fields as indicated by broken lines in FIG. 4.

At the time of initiation, the processor 65-Cc initializes all counts contained in the count fields of all records of the VPN-NIF table 65T-Cc to “0.”

The controlling part 53-C performs the following processing by cooperating with the network interfacing parts 52-C1 to 52-C3:

Acquires routing information as appropriate according to a predetermined routing protocol in the same manner as in the conventional example, and selects an optimum route on the basis of the acquired routing information.

Converts pieces of routing information corresponding to the respective selected routes among the acquired pieces of routing information into pairs of a CAM word and an SRAM word (described above), and accumulates those as they are produced so as to be correlated with VPN identifiers indicating corresponding VPNs.

Newly accumulated pairs of a CAM word and an SRAM word are delivered to all the processors 65-C1 to 65-C3 together with corresponding VPN identifiers (indicated by symbol (1) in FIG. 5).

The processor 65-Cc performs the following processing every time it recognizes a CAM word, an SRAM word, and a VPN identifier that are delivered in the above-described manner:

(1) Judges whether the VPN-NIF table 65T-Cc has a record (hereinafter referred to as “first specific record”) whose VPN identifier field has the same value as the recognized one (indicated by symbol (2) in FIG. 5). If the judgment result is “false,” discards the recognized CAM word, SRAM word, and VPN identifier.

(2) If the above judgment result is “true,” judges whether the count of the count field of the first specific record is equal to “0.” Only when the judgment result is “true”, performs the following processing (indicated by symbol (3) in FIG. 5).

Stores the delivered CAM word and SRAM word in the CAM 66-Cc and the SRAM 67-Cc, respectively.

Increments the counts of the count field of the first specific record individually as long as the counts do not overflow.

Recognizing that any one of the above-mentioned routes should be deleted, the controlling part 53-C determines a CAM word and an SRAM word corresponding to the route and a VPN identifier indicating a VPN that is correlated with (assigned to) the route and delivers the determined CAM word, SRAM word, and VPN identifier to all the processors 65C1 to 65-C3 (indicated by symbol (4) in FIG. 5).

The processor 65-Cc performs the following processing every time it recognizes a CAM word, an SRAM word, and a VPN identifier that have been delivered in the above-described manner:

(1) Determines, among the records of the VPN-NIF table 65-Cc, a record (hereinafter referred to as “second specific record”) whose VPN identifier field has the same VPN identifier as the recognized one (indicated by symbol (5) in FIG. 5).

(2) Judges whether the count of the count field of the second specific record is greater than or equal to “1” (indicated by symbol (6) in FIG. 5). Only when the judgment result is “true”, performs the following processing (indicated by symbol (7) in FIG. 5):

Deletes the CAM word and the SRAM word concerned from the CAM 66-Cc and the SRAM 67-Cc.

Sets the count of the count field of the second specific record to “0.”

(3) If the judgment result is “false,” decrements the count of the count field of the second specific record as long as the count does not underflow.

That is, the pair of the CAM 66-C1 and the SRAM 67-C1, the pair of the CAM 66-C2 and the SRAM 67-C2, and the pair of the CAM 66-C3 and the SRAM 67-C3 store therein pairs of a CAM word and an SRAM word relating only to VPNs to be accommodated via the network interfaces 52-C1 to 52-C3, respectively, while the processors 65-C1 to 65-C3 perform distributed processing in the above-described manner.

Therefore, according to this embodiment, the pair of the CAM 66-C1 and the SRAM 67-C1, the pair of the CAM 66-C2 and the SRAM 67-C2,.and the pair of the CAM 66-C3 and the SRAM 67-C3 store therein pairs of a CAM word and an SRAM word to be used only for the formation and accommodation of VPNs that are actually effective without increasing the throughput of the controlling part 53-C.

Further, the router 41-C can accommodate therein, with high reliability and low cost, a much larger number of VPNs than in the conventional example without causing any substantial alterations in hardware.

According to this embodiment, it is not necessary to change the number of entries of an existing CAM which is provided in each of these network interfacing parts as long as the load taken for formation and accommodation of these VPNs is distributed to a maximum mountable number of network interfacing parts, even if the number of VPNs to be accommodated is large.

In each of the above embodiments, each VPN is formed between the routers 41-1 to 41-3 that are provided as nodes in the global IP network 42.

However, the invention is not limited to such a case. For example, the invention can similarly be applied to a case that routers to be used for accommodating VPNs are accommodated in different networks, as long as inter-network interfacing between these networks is performed reliably.

In each of the above embodiments, routing information is acquired according to a predetermined routing protocol and CAM words and SRAM words suitable for the acquired routing information are generated as appropriate.

However, the invention is not limited to such a configuration. For example, the invention can similarly applied to a case that pieces of routing information are set collectively as office data or other information or part of them are deleted as appropriate (this may be done under man-machine interfacing with personnel who is engaged in maintenance and operation).

In each of the above embodiments, the crossbar switch 51-C is provided in the router 41-C. However, the invention is not limited to such a configuration. The crossbar switch 51-C may be replaced by another device that is connected to the router 41-C via a certain transmission path as long as the routing controlling part 62-Cc performed the above-described processing in response to an output port number, an XB port number, and control information (contained in an SRAM word) and transmission information that are delivered in the above-described manner and the routing controlling part 62-Cc, the filtering controlling part 63-Cc, and the line controlling part 64-Cc cooperate with each other properly.

In each of the above embodiments, the network interfacing part 52-Cc is provided with a function that enables accommodation of only desired VPNs. However, for example, the network interfacing part 52-Cc may have, in addition to that function, a function that enables network interfacing between different networks or segments.

In each of the above embodiments, the controlling part 53-C is connected to the network interfacing parts 52-C1 to 52-C3 and the crossbar switch 51-C via a bus-like or mesh-like link and is a unit (or package) that is separate from the crossbar switch 51-C.

However, the invention is not limited to such a configuration. The controlling part 53-C may be combined entirely or partially with the crossbar switch 51-C and is distributed on a port-by-port basis (the network interfacing parts 52-C1 to 52-C3 are connected to the respective ports) so that load distribution and functional distribution are attained and wiring is simplified.

In each of the above embodiments, an output port number, an XB port number, and control information that are contained in an SRAM word are delivered as appropriate to the network interfacing part 52-Cc under the control of the controlling part 53-C.

However, the invention is not limited to such a configuration. Timing (may be determined in the course of man-machine interfacing for maintenance or operation) for the controlling part 53-C to deliver an output port number, an XB port number, and control information may be determined autonomously by the network interfacing part 52-Cc and communicated to the controlling part 53-C.

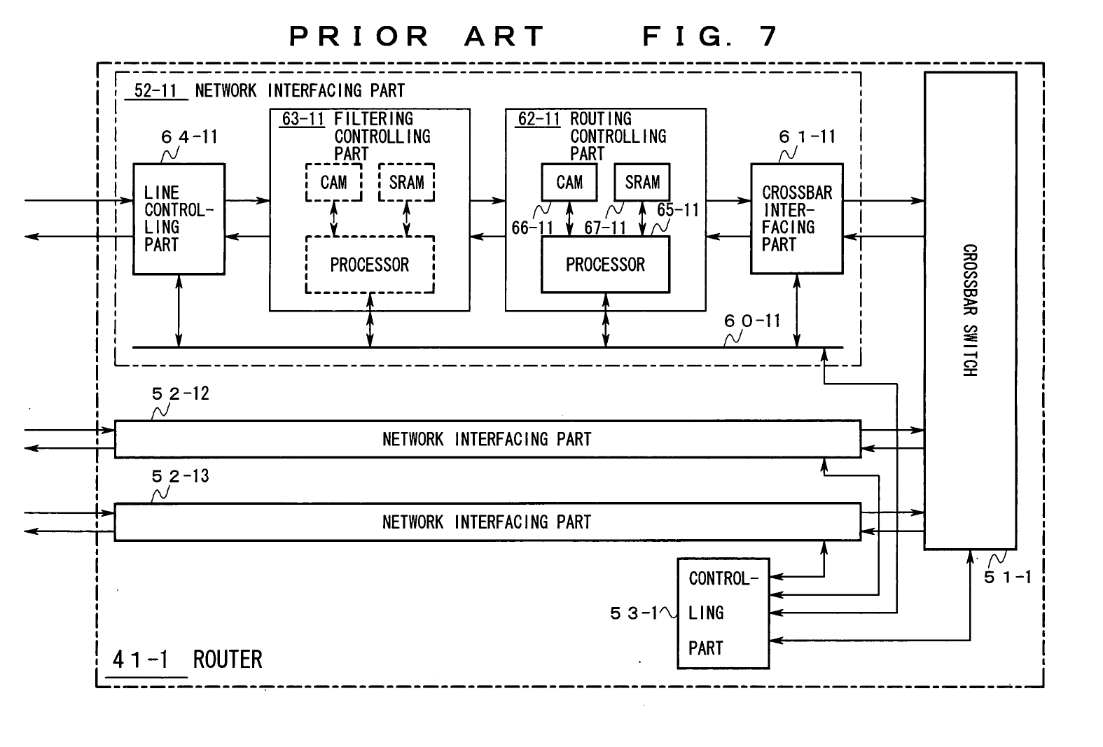

In each of the above embodiments, the number of entries of the CAM 66-Cc only is reduced. However, according to the invention, it is also possible to reduce the number of entries of a CAM provided in the filtering controlling part 63-Cc (indicated by a broken line in FIG. 7) by eliminating redundancy of routing information and other control information that are stored in the CAM and are to be used for filtering.

In each of the above embodiments, a single network interfacing part is used for accommodating each VPN in each of the routers 41-1 to 41-3. However, the invention is not limited to such a configuration. For example, the number of network interfacing parts used mainly for each VPN may vary in the cases where the traffic varies widely from one VPN to another, or a communication service is provided via VPNs to a plurality of sites which belong to a single business enterprise and are closest to a single router.

The invention is not limited to the above embodiments and various modifications may be made without departing from the spirit and scope of the invention. Any improvement may be made in part or all of the components.

What is claimed is:

1. A communication apparatus comprising:
a plurality of interfacing sections interfacing with links and each having a CAM, for routing or filtering according to information that is stored in the CAM, the links being used for accommodating VPNs, respectively;
a storage section for registering therein in advance a combination of identifiers of interfacing sections accommodating the VPNs therein individually, the interfacing sections being of the plurality of interfacing sections; and
a controlling section for requesting one of the interfacing sections to write routing information to a CAM of the one of the interfacing sections, the one of the interfacing sections being designated by an identifier which is registered in the storage section in association with a VPN to which the routing information is applied.

2. The communication apparatus according to claim 1, wherein
the controlling section comprehends contents of routing information written to the respective CAMs of the interfacing sections, and omits requesting for writing overlapping pieces of routing information to the CAMs when the routing information overlaps the contents of the written routing information.

3. The communication apparatus according to claim 1, wherein
the plurality of interfacing sections maintain uniqueness of each piece of routing information that is written to the respective CAMs of the plurality of interfacing sections.

4. A communication apparatus comprising:
a plurality of interfacing sections interfacing with links and each having a CAM, for routing or filtering according to information that is stored in the CAM, the links being used for accommodating VPNs, respectively; and
a controlling section for delivering, to all of the plurality of interfacing sections, routing information to be applied to the VPNs, wherein
the plurality of interfacing sections write routing information to their respective CAMs, the route information being of the delivered routing information and corresponding to the VPNs that are accommodated via the links.

5. The communication apparatus according to claim 1, further comprising a switching section for delivering a packet among the plurality of interfacing sections, the packet being a packet whose transmission source and/or destination is/are accommodated in one of the VPNs.

6. The communication apparatus according to claim 5, wherein
the plurality of interfacing sections and the switching section interface with different autonomous systems or segments in one of a data link layer and a transport layer, the different autonomous systems or segments being intervenient in all or part of the VPNs.

7. The communication apparatus according to claim 5, wherein
one or both of a function and a load of the controlling section is/are distributed to ports that are provided in the switching section and correspond to the plurality of interfacing sections.

8. The communication apparatus according to claim 5, wherein
the switching section delivers all of the routing information between the controlling section and the plurality of interfacing sections.

9. The communication apparatus according to claim 6, wherein
the switching section delivers all of the routing information between the controlling section and the plurality of interfacing sections.

10. The communication apparatus according to claim 7, wherein
the switching section delivers all of the routing information between the controlling section and the plurality of interfacing sections.

11. The communication apparatus according to claim 1, wherein
the controlling section delivers routing information to the plurality of interfacing sections via a communication link.

12. The communication apparatus according to claim 4, wherein
the controlling section delivers routing information to the plurality of interfacing sections via a communication link.

13. A network interfacing device comprising:
an interfacing section interfacing with a link that is used for accommodating a VPN;
a communication processing section for performing routing or filtering relating to the VPN according to information that is stored in a CAM; and
a controlling section for writing routing information to the CAM, the routing information being delivered from an exterior and relating only to the VPN.

14. The network interfacing device according to claim 13, wherein
the controlling section maintains uniqueness of the information stored in the CAM.

15. The network interfacing device according to claim 13, wherein
the controlling section requests the exterior to supply routing information when a predetermined event has occurred, the routing information being used for updating the information stored in the CAM.

16. The network interfacing device according to claim 14, wherein
the controlling section requests the exterior to supply routing information when a predetermined event has occurred, the routing information being used for updating the information stored in the CAM.

17. The network interfacing device according to claim 13, wherein
the controlling section acquires the externally delivered routing information via a port connected to the communication processing section, the port being one of ports that are provided in a switch realizing the routing or filtering in cooperation with other network interfacing devices.

18. The network interfacing device according to claim 14, wherein
the controlling section acquires the externally delivered routing information via a port connected to the communication processing section, the port being one of ports that are provided in a switch realizing the routing or filtering in cooperation with other network interfacing devices.

19. The network interfacing device according to claim 15, wherein
the controlling section acquires the externally delivered routing information via a port connected to the communication processing section, the port being one of ports that are provided in a switch realizing the routing or filtering in cooperation with other network interfacing devices.
